(19) United States
(12) Patent Application Publication
(10) Pub. No.: US 2025/0106804 A1
(43) Pub. Date: Mar. 27, 2025

(54) REGISTRATION HANDLING FOR UE WITH SATELLITE IN STORE AND FORWARD MODE

(71) Applicant: Samsung Electronics Co., Ltd., Suwon-si (KR)

(72) Inventors: Sidhant JAIN, Bangalore (IN); Lalith KUMAR, Bangalore (IN); Aman AGARWAL, Bangalore (IN); Dinesh Rooparam CHOUDHARY, Bangalore (IN); Varini GUPTA, Bangalore (IN)

(21) Appl. No.: 18/930,580

(22) Filed: Oct. 29, 2024

Related U.S. Application Data
(63) Continuation of application No. PCT/KR2024/014541, filed on Sep. 25, 2024.

(30) Foreign Application Priority Data
Sep. 27, 2023 (IN) 202341065027
Sep. 10, 2024 (IN) 2023 41065027

(51) Int. Cl. H04W 60/04; H04W 64/00; H04W 76/20; H04W 84/06

(52) U.S. Cl. CPC H04W 60/04; H04W 64/00; H04W 76/20; H04W 84/06

(57) ABSTRACT

A method performed by a user equipment (UE) for signaling using satellite access in a 4^{th} generation (4G) or 5^{th} generation (5G) network is provided. The method includes receiving, by the UE, a signal from a first network apparatus associated with a satellite when a feeder link is available between the first network apparatus and the second network apparatus associated with a ground network, storing, by the UE, the signal received from the first network apparatus, and determining, by the UE, a third network apparatus associated with the satellite to transmit a response signaling to a user equipment (UE) upon receiving the signal using the first network apparatus based on an expected location of the UE.

### CROSS-REFERENCE TO RELATED APPLICATION(S)

This application is a continuation application, claiming priority under § 365(c), of an International application No. PCT/KR2024/014541, filed on Sep. 25, 2024, which is based on and claims the benefit of an Indian Provisional application number 202341065027, filed on Sep. 27, 2023, in the Indian Intellectual Property Office, and of an Indian Complete application number 202341065027, filed on Sep. 10, 2024, in the Indian Intellectual Property Office, the disclosure of each of which is incorporated by reference herein in its entirety.

### FIELD OF INVENTION

The disclosure relates to the field of satellite communication. More particularly, the disclosure relates to a system and method for performing signaling using satellite access in a 4th generation (4G) or 5th generation (5G) network.

### BACKGROUND

A 5G system with satellite access must provide service continuity across new radio (NR) terrestrial access networks and NR satellite access networks controlled by the same operator or two distinct operators with an agreement. The non terrestrial networks (NTN) and TN might operate in two distinct frequency bands (e.g., frequency range (FR1) versus FR2) or in the same frequency band (e.g., FR1 or FR2). The satellite system or satellite access described in this embodiment is applicable to both 5G and 4G systems, as well as any radio access technology (RAT) with satellite access. The terms satellite Third Generation Partnership Project (3GPP) access, satellite access, satellite access network, NR satellite access network, satellite Next Generation Radio Access Network (NG-RAN) access technology and NR satellite access have been interchangeably used and have the same meaning. The store and forward (S&F) satellite operation in a 4G or 5G system with satellite access is intended to provide some level of communication service to user equipments (UEs) under satellite coverage with intermittent/temporary satellite connectivity (e.g., when the satellite is not connected via a feeder link or via ISL to the ground network) for delay-tolerant communication service.

The term “S&F” service is commonly used in the disciplines of delay-tolerant networking and disruption-tolerant networking. In the context of 3GPP, short message service (SMS) is a service that could be assimilated to an S&F service because there is no need for end-to-end connectivity between the end-points (e.g., one end-point can be a UE and the other an application server), but only between the end-points and the short message service center (SMSC), which acts as an intermediate node in charge of storing and relying. The support of S&F Satellite operation is ideal for delivering delay-tolerant/non-real-time Internet of things (IoT) satellite services using Non-Geostationary Satellite Orbit (NGSO) satellites.

Currently, all attach or registration procedures for terrestrial networks are established so that responses from network organizations may be obtained in a fairly short amount of time. When the satellite network is in S&F Mode (e.g., a feeder connection is unavailable) and the UE is not registered in the current tracking area identity (TAI), there is no way to manage attach/registration for such a UE. If the UE is turned off and then turned back on, or if it falls out of service and then recovers, the present standards do not specify how the UE initiates the registration/attachment or how the satellite processes the registration/attachment request while it is operating in S&F mode.

The satellite(s) that do not have UE information/UE context/UE subscription data may be unable to handle the attach request/registration request/non-access stratum (NAS) signaling/access stratum (AS) signaling received from the UE. If there are many satellites servicing the UE, the network may have difficulty determining which satellite(s) will service the UE first, either at the UE's current position or UE's position at a later point of time.

The above information is presented as background information only to assist with an understanding of the disclosure. No determination has been made, and no assertion is made, as to whether any of the above might be applicable as prior art with regard to the disclosure.

### OBJECT OF INVENTION

Aspects of the disclosure are to address at least the above-mentioned problems and/or disadvantages and to provide at least the advantages described below. Accordingly, an aspect of the disclosure is to provide a method and system for performing signaling using satellite access in a 5G or 4G network.

Another aspect of the disclosure is to provide a UE to send the attach request or registration request to a Mobility Management Entity (MME)/Access and Mobility Management Function (AMF) on-board the satellite when a service link is available.

Another aspect of the disclosure is to enable the MME/AMF-on-board or any other network function (NF) on-board the satellite to store the attach request/registration request/received from the UE. When the satellite has a feeder link available, the MME/AMF-on-board or any other NF on-board communicates the attach request/registration request to an MME/AMF on the ground.

Another aspect of the disclosure is to enable the NF/core network (CN) entity on ground to decide and send a response based on the attach request/registration request or any other NAS/AS signaling received for the UE via the same satellite or via a different satellite. The MME/AMF or any other NF/CN entity/application function (AF) may identify which satellites will service the UE's current or expected future location and respond with any allowed satellite.

Another aspect of the disclosure is to enable the satellite (MME/AMF on-board or any other NF/CN entity) to store the response received from the MME/AMF on ground when the feeder link is available.

Another aspect of the disclosure is to enable the satellite to deliver the response message/signal (attach/registration accept or attach/registration reject) to the UE when the satellite reaches the location where the service link with the UE can be established.

Additional aspects will be set forth in part in the description which follows and, in part, will be apparent from the description, or may be learned by practice of the presented embodiments.

### SUMMARY

In accordance with an aspect of the disclosure, a method performed by a user equipment (UE) for signaling using satellite access in a 4th generation (4G) or 5th generation (5G) network is provided. The method includes detecting, by the UE, whether a service link is available between the UE and a first network apparatus associated with a satellite, generating, by the UE, a signal to be transmitted to the first network apparatus when the service link is available between the UE and the first network apparatus, and receiving, by the UE, a response to the signal transmitted from a third network apparatus associated with the satellite when the service link is available between the UE and the third network apparatus.

In accordance with another aspect of the disclosure, a method performed by a first network apparatus for signaling using satellite access in a 4th generation (4G) or 5th generation (5G) network is provided. The method includes receiving, by the first network apparatus associated with a satellite, a signal from a user equipment (UE) to initiate an attach/registration procedure or any other non-access stratum (NAS) or access stratum (AS) procedure, determining, by the first network apparatus, whether a feeder link is available between the first network apparatus and a second network apparatus associated with a ground network, and performing one of transmitting the signal received to the second network apparatus when the feeder link is available between the first network apparatus and the second network apparatus, or storing the signal received when the feeder link is not available between the first network apparatus and the second network apparatus.

In an embodiment, the signal includes at least one of a non-access stratum (NAS) message, an access stratum (AS) message, a NAS signal, an AS signal, a control plane message, a user plane message, an application data.

In an embodiment, the signal sent by the UE includes at least one of a UE identifier and a UE location identifier.

In an embodiment, the method includes receiving a response signal from the second network apparatus upon transmission of the signal from the first network apparatus when the feeder link is available between the second network apparatus and third network apparatus. The third network apparatus stores the response signal received from the second network apparatus when the service link between the third network apparatus and the UE is not available.

In an embodiment, the response signal includes an attach accept message or an attach reject message or any other NAS or AS message generated by the ground station in response to the signal sent by the UE.

In accordance with another aspect of the disclosure, a method performed by a second network apparatus for signaling using satellite access in a 4th generation (4G) or 5th generation (5G) network is provided. The method includes receiving, by the second network apparatus, a signal from a first network apparatus associated with a satellite when a feeder link is available between the first network apparatus and the second network apparatus, storing, by the second network apparatus, the signal received from the first network apparatus, and determining, by the second network apparatus, a third network apparatus associated with the satellite to transmit a response signal to a user equipment (UE) upon receiving the signal from the first network apparatus based on a current or expected location of the UE.

In an embodiment, determining, by the second network apparatus, the third network apparatus associated with a satellite to transmit a response signal to a user equipment (UE) upon receiving the signal using the first network apparatus based on current location of the UE or an expected location of the UE includes determining the third network apparatus using at least one of the second network apparatus itself and a plurality of other network apparatuses associated with the ground network.

In an embodiment, the second network apparatus determines the third network apparatus using a plurality of parameters.

In an embodiment, the plurality of parameters include at least one of a rotation information, an ephemeris information, a satellite coverage availability information (SCAI), current location of the UE, and an expected location of the UE.

In an embodiment, the first network apparatus and third network apparatus may be a same network apparatus or a different network apparatus.

In an embodiment, the second network apparatus stores the response to signal by the first network apparatus until at least one other third network apparatus of the plurality of other third network apparatuses is determined.

In accordance with another aspect of the disclosure, a user equipment (UE) for performing signaling using satellite access in a 4th generation (4G) or 5th generation (5G) network is provided. The UE includes memory, one or more processors coupled to the memory, and a UE controller communicatively coupled to the memory and the one or more processors, wherein the UE controller is configured to detect whether a service link is available between the UE and a first network apparatus associated with a satellite, generate a signal to be transmitted to the first network apparatus when the service link is available between the UE and the first network apparatus, receive a response to the signal transmitted from a third network apparatus associated with the satellite when the service link is available between the UE and the third network apparatus.

In accordance with another aspect of the disclosure, a first network apparatus for performing signaling using satellite access in a 4th generation (4G) or 5th generation (5G) network is provided. The first network apparatus includes memory, one or more processors coupled to the memory, and a first controller communicatively coupled to the memory and the one or more processors, wherein the first controller is configured to receive a signal from a user equipment (UE) to initiate an attach/registration procedure or any other NAS/AS procedure, determine whether a feeder link is available between the first network apparatus and a second network apparatus associated with a ground network, perform one of transmit the signal received to the second network apparatus when the feeder link is available between the first network apparatus and the second network apparatus, or store the signal received when the feeder link is not available between the first network apparatus and the second network apparatus.

In an embodiment, the signal includes at least one of a non-access stratum (NAS) message, an access stratum (AS) message, a NAS signal, an AS signal, a control plane message, and a user plane message, an application data.

In an embodiment, the signal sent by the UE includes at least one of a UE identifier and a UE location identifier.

In an embodiment, the first controller receives a response signal from the second network apparatus upon transmission of the signal from the first network apparatus when the feeder link is available between the second network apparatus and third network apparatus. The third network apparatus stores the response signal received from the second network apparatus.

In an embodiment, the response signal includes an attach accept message or an attach reject message.

In accordance with another aspect of the disclosure, a second network apparatus for performing signaling using satellite access in a 4^{th} generation (4G) or 5^{th} generation (5G) network is provided. The second network apparatus includes memory, one or more processors coupled to the memory, and a second controller communicatively coupled to the one or more processors and the memory, wherein the second controller is configured to receive a signal from a first network apparatus associated with a satellite when a feeder link is available between the first network apparatus and the second network apparatus, store the signal received from the first network apparatus, and determine a third network apparatus associated with the satellite to transmit a response signal to a user equipment (UE) upon receiving the signal using the first network apparatus based on current location of the UE or an expected location of the UE.

In an embodiment, the second controller determines the third network apparatus using at least one of the second network apparatus itself and a plurality of other network apparatuses associated with the ground network.

In an embodiment, the second network apparatus determines the third network apparatus using a plurality of parameters.

In an embodiment, the plurality of parameters include at least one of a rotation information, an ephemeris information, a satellite coverage availability information (SCAI), current location of the UE, and an expected location of the UE.

In an embodiment, the first network apparatus and third network apparatus may be a same network apparatus or a different network apparatus.

In an embodiment, the second network apparatus stores the response to signal by the first network apparatus until at least one other third network apparatus of the plurality of other third network apparatuses is determined.

In accordance with another aspect of the disclosure, one or more non-transitory computer-readable storage media storing one or more computer programs including computer-executable instructions that, when executed by one or more processors of a user equipment (UE) individually or collectively, cause the UE to perform operations, the operations include detecting, by the user equipment (UE), whether a service link is available between the UE and a first network apparatus associated with a satellite, generating, by the UE, a signal to be transmitted to the first network apparatus when the service link is available between the UE and the first network apparatus, and receiving, by the UE, a response to the signal transmitted from a third network apparatus associated with the satellite when the service link is available between the UE and the third network apparatus.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1 is a schematic diagram that illustrates a normal/default satellite operation mode according to the related art;

FIG. 2 is a schematic diagram that illustrates a S&F satellite operation mode according to the related art;

FIG. 3 is a sequence diagram that illustrates initiation of an attach procedure according to the related art;

FIG. 4 is a block diagram that illustrates a schematic of a UE implemented to carry out the disclosed subject matter according to an embodiment of the disclosure;

FIG. 5 is a block diagram that illustrates a schematic of a first network apparatus implemented to carry out the disclosed subject matter according to an embodiment of the disclosure;

FIG. 6 is a block diagram that illustrates a schematic of a second network apparatus implemented to carry out the disclosed subject matter according to an embodiment of the disclosure;

FIG. 7 is a block diagram that illustrates a 5G satellite architecture with split AMF according to an embodiment of the disclosure;

FIG. 8 is a block diagram that illustrates a 4G satellite architecture with split MME according to an embodiment of the disclosure;

FIG. 9 is a sequence diagram that illustrates a registration and uplink procedure according to an embodiment of the disclosure;

FIG. 10 is a sequence diagram that illustrates the registration and uplink procedure using timers according to an embodiment of the disclosure;

FIG. 11 is a sequence diagram that illustrates the registration and uplink procedure between two satellites according to an embodiment of the disclosure;

FIG. 12 is a flow chart that illustrate a method for performing signaling using satellite access in a 5G network by a UE according to an embodiment of the disclosure;

FIG. 13 is a flow chart that illustrate a method for performing signaling using satellite access in a 5G network by a first network apparatus according to an embodiment of the disclosure; and

FIG. 14 is a flow chart that illustrate a method for performing signaling using satellite access in a 5G network by a second network apparatus according to an embodiment of the disclosure.

Throughout the drawings, it should be noted that like reference numbers are used to depict the same or similar elements, features, and structures.

### DETAILED DESCRIPTION OF INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various examples of the disclosure described below, a hardware approach will be described as an example. However, since various embodiments of the disclosure may include a technology that utilizes both the hardware-based and the software-based approaches, they are not intended to exclude the software-based approach.

As used herein, the terms referring to merging (e.g., merging, grouping, combination, aggregation, joint, integration, unifying), the terms referring to signals (e.g., packet, message, signal, information, signaling), the terms referring to resources (e.g. section, symbol, slot, subframe, radio frame, subcarrier, resource element (RE), resource block (RB), bandwidth part (BWP), opportunity), the terms used to refer to any operation state (e.g., step, operation, procedure), the terms referring to data (e.g. packet, message, user stream, information, bit, symbol, codeword), the terms referring to a channel, the terms referring to a network entity (e.g., distributed unit (DU), radio unit (RU), central unit (CU), control plane (CU-CP), user plane (CU-UP), O-DU-open radio access network (O-RAN) DU), O-RU (O-RAN RU), O-CU (O-RAN CU), O-CU-UP (O-RAN CU-CP), O-CU-CP (O-RAN CU-CP)), the terms referring to the components of an apparatus or device, or the like are only illustrated for convenience of description in the disclosure. Therefore, the disclosure is not limited to those terms described below, and other terms having the same or equivalent technical meaning may be used therefor. Further, as used herein, the terms, such as ‘˜module’, ‘˜unit’, ‘˜part’, ‘˜body’, or the like may refer to at least one shape of structure or a unit for processing a certain function.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {′C′, ‘D’, or ‘C’ and ‘D’}.

The disclosure describes various embodiments using terms used in some communication standards (e.g., 3rd Generation Partnership Project (3GPP), extensible radio access network (xRAN), open-radio access network (O-RAN) or the like), but it is only of an example for explanation, and the various embodiments of the disclosure may be easily modified even in other communication systems and applied thereto.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

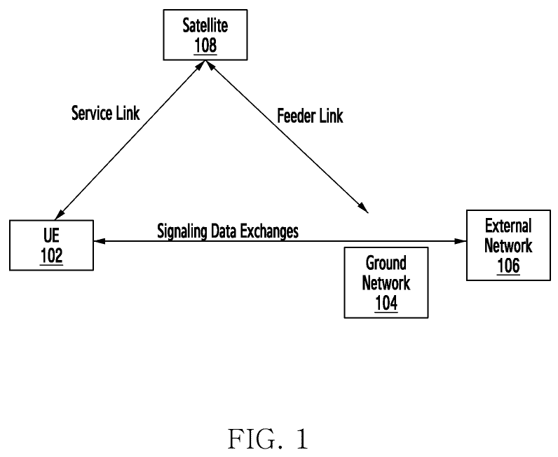

FIG. 1 is a schematic diagram that illustrates a normal/default satellite operation mode according to the related art.

Referring to FIG. 1, the schematic diagram includes a user equipment (UE) (102), a ground network (104), an external network (106), and a satellite (108). For example, the UE (102) may include an IoT device and the external network (106) may include an IoT application server. In the normal/default satellite operating mode, the signaling and data traffic exchange between the UE (102) with satellite access and the distant ground network (104) requires both the service and feeder connections to be operational at the same time. As a result, when the UE (102) interacts with the satellite (108) via the service link, a continuous end-to-end connection channel exists between the UE (102), the satellite (108), and the ground network (104).

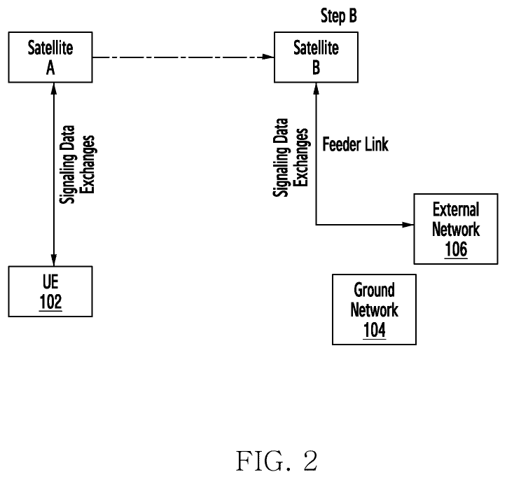

FIG. 2 is a schematic diagram that illustrates a S&F satellite operation mode according to the related art.

Referring to FIG. 2, the S&F satellite operating mode handles the end-to-end exchange of signaling/data traffic as a combination of two phases that are not contemporaneous in time (steps A and B). In step A, the UE (102) and the satellite (108) exchange signals/data without the satellite (108) being linked to the ground network (104). For example, the satellite (108) can run the service link without an active feeder link connection. In step B, connection between the satellite (108) and the ground network (104) is established, allowing communication between the two to occur. Thus, the satellite (108) moves from being connected to the UE (102) in step A to being connected to the ground network (104) in step B.

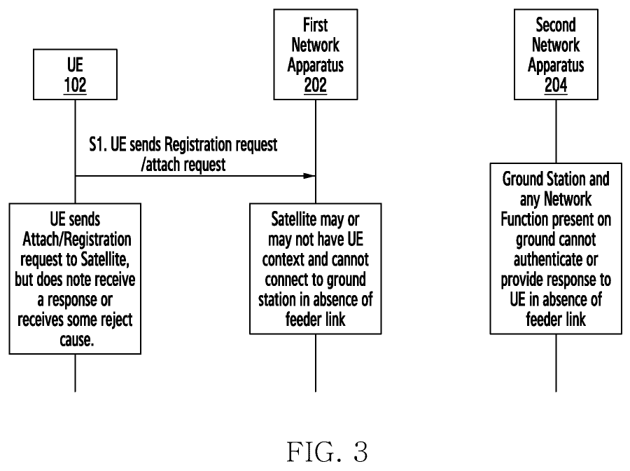

FIG. 3 is a sequence diagram that illustrates initiation of an attach procedure according to the related art.

Referring to FIG. 3, as shown in the sequence diagram, the UE (102) is in communication with a first network apparatus (202) and a second network apparatus (204). The first network apparatus (202) may correspond to an MME/AMF on board the satellite (108) and the second network apparatus may correspond to an MME/AMF on the ground station or ground network (104).

At step S1, the UE (102) sends a registration request/attach request to the first network apparatus (202). However, the first network apparatus (202) does not respond or sends a reject message to the UE (102). The first network apparatus (202) associated with the satellite (108) may or may not have a UE (102) context and is unable to connect to the ground station or ground network (104) in the absence of a feeder link. Furthermore, the ground network (104) or any network function present on the ground cannot authenticate and respond to the UE (102) in the absence of a feeder link. There is no architecture defined in existing standards for handling store and forward scenarios.

The proposed solution describes a method for the UE (102) to connect/register with a satellite network (e.g., the first network apparatus (202)) when the satellite (108) does not have a feeder link available, such as when it is operating in S&F mode. Without this solution, the UE (102) will be unable to access satellite network services in S&F Mode if it has not previously registered with the satellite network. The proposed solution allows the ground MME (second network apparatus (204) to pick a satellite that will reach the present location first, resulting in faster response delivery to the UE (102) and completion of the attach/registration operation.

In an embodiment, the term enterprise mobility management (EMM) sublayer states are at least one of the below:
1) EMM-NULL
2) EMM-DEREGISTERED
   a) EMM-DEREGISTERED.NORMAL-SERVICE
   b) EMM-DEREGISTERED.LIMITED-SERVICE
   c) EMM-DEREGISTERED.ATTEMPTING-TO-ATTACH
   d) EMM-DEREGISTERED.PLMN-SEARCH
   e) EMM-DEREGISTERED.NO-IMSI
   f) EMM-DEREGISTERED.ATTACH-NEEDED
   g) EMM-DEREGISTERED.NO-CELL-AVAILABLE
   h) EMM-DEREGISTERED.eCALL-INACTIVE
3) EMM-REGISTERED-INITIATED
4) EMM-REGISTERED
   a) EMM-REGISTERED.NORMAL-SERVICE
   b) EMM-REGISTERED.ATTEMPTING-TO-UPDATE
   c) EMM-REGISTERED.LIMITED-SERVICE
   d) EMM-REGISTERED.PLMN-SEARCH
   e) EMM-REGISTERED.UPDATE-NEEDED
   f) EMM-REGISTERED.NO-CELL-AVAILABLE
   g) EMM-REGISTERED.ATTEMPTING-TO-UPDATE-MM
   h) EMM-REGISTERED.IMSI-DETACH-INITIATED
5) EMM-DEREGISTERED-INITIATED
6) EMM-TRACKING-AREA-UPDATING-INITIATED
7) EMM-SERVICE-REQUEST-INITIATED

The term 5G mobility management (5GMM) sublayer state in this embodiment is at least one of the below:
1) 5GMM-NULL
2) 5GMM-DEREGISTERED
   a) 5GMM-DEREGISTERED.NORMAL-SERVICE
   b) 5GMM-DEREGISTERED.LIMITED-SERVICE
   c) 5GMM-DEREGISTERED.ATTEMPTING-REGISTRATION
   d) 5GMM-DEREGISTERED.PLMN-SEARCH
   e) 5GMM-DEREGISTERED.NO-SUPI
   f) 5GMM-DEREGISTERED.NO-CELL-AVAILABLE
   g) 5GMM-DEREGISTERED.eCALL-INACTIVE
   h) 5GMM-DEREGISTERED.INITIAL-REGISTRATION-NEEDED
3) 5GMM-REGISTERED-INITIATED
4) 5GMM-REGISTERED
   a) 5GMM-REGISTERED.NORMAL-SERVICE
   b) 5GMM-REGISTERED.NON-ALLOWED-SERVICE
   c) 5GMM-REGISTERED.ATTEMPTING-REGISTRATION-UPDATE
   d) 5GMM-REGISTERED.LIMITED-SERVICE
   e) 5GMM-REGISTERED.PLMN-SEARCH
   f) 5GMM-REGISTERED.NO-CELL-AVAILABLE
   g) 5GMM-REGISTERED.UPDATE-NEEDED
5) 5GMM-DEREGISTERED-INITIATED
6) 5GMM-SERVICE-REQUEST-INITIATED

Visited public land mobile network (PLMN) (VPLMN): This is a PLMN different from the home PLMN (HPLMN) (if the equivalent home PLMN (EHPLMN) list is not present or is empty) or different from an EHPLMN (if the EHPLMN list is present).

Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.

Available PLMN: PLMN(s) in the given area which is/are broadcasting capability to provide wireless communication services to the UE.

Camped on a cell: The MS (ME if there is no SIM) has completed the cell selection/reselection process and has chosen a cell from which it plans to receive all available services. Note that the services may be limited, and that the PLMN or the stand-alone non-public network (SNPN) may not be aware of the existence of the MS (ME) within the chosen cell.

EHPLMN: Any of the PLMN entries contained in the Equivalent HPLMN list.

Equivalent HPLMN list: To allow provision for multiple HPLMN codes, PLMN codes that are present within this list shall replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list then it shall be treated as a Visited PLMN for PLMN selection purposes.

Home PLMN: This is a PLMN where the mobile country code (MCC) and mobile network code (MNC) of the PLMN identity match the MCC and MNC of the IMSI.

Registered PLMN (RPLMN): This is the PLMN on which certain LR (location registration which is also called as registration procedure) outcomes have occurred. In a shared network the RPLMN is the PLMN defined by the PLMN identity of the CN operator that has accepted the LR.

Registration: This is the process of camping on a cell of the PLMN or the SNPN and doing any necessary LRs.

UPLMN: PLMN/access technology combination in the “User Controlled PLMN Selector with Access Technology” data file in the SIM (in priority order).

OPLMN: PLMN/access technology combination in the “Operator Controlled PLMN Selector with Access Technology” data file in the SIM (in priority order) or stored in the ME (in priority order).

Feeder Link: Feeder link can be defined as a wireless link between the NTN Gateway and the satellite.

Service Link: Service link is the radio link between a user equipment (UE) and a satellite.

The term RAT as defined in this embodiment can be one of the following:
NG-RAN
5G, 4G, 3^{rd} generation (3G), 2^{nd} generation (2G)
EPS, 5GS
NR
NR in unlicensed bands
NR(LEO) satellite access
NR(MEO) satellite access
NR(GEO) satellite access
NR(OTHERSAT) satellite access
NR RedCap
E-UTRA
E-UTRA in unlicensed bands
NB-IoT
WB-IoT
LTE-M

5GS registration type are:
initial registration
mobility registration updating
periodic registration updating
emergency registration
SNPN onboarding registration
disaster roaming initial registration; or
disaster roaming mobility registration updating”

In an embodiment, not set the registration type to disaster roaming initial registration or disaster roaming mobility registration updating means 5GS registration type is set to value other than “disaster roaming initial registration” or ““disaster roaming mobility registration updating” at least one of:
initial registration
mobility registration updating
periodic registration updating
emergency registration
SNPN onboarding registration
   PLMN Selection as Per 23.122 without RPLMN:

The MS selects and attempts registration on any PLMN/access technology combinations, if available and allowable, in the following order:
either the HPLMN (if the EHPLMN list is not present or is empty) or the highest priority EHPLMN that is available (if the EHPLMN list is present);
each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order;

Other PLMN/access technology combinations in order of decreasing signal quality.

PLMN Selection as Per 23.122 with RPLMN:

The MS selects and attempts registration on any PLMN/access technology combinations, if available and allowable, in the following order:
either the RPLMN or the Last registered PLMN;
either the HPLMN (if the EHPLMN list is not present or is empty) or the highest priority EHPLMN that is available (if the EHPLMN list is present);
each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order;
other PLMN/access technology combinations in order of decreasing signal quality.

The Network (e.g., the first network apparatus (202) and the second network apparatus (204)) used in this embodiment is explained using any 5G Core Network Function for example, AMF. However, the network could be any 5G/evolved universal mobile telecommunications system (UMTS) terrestrial radio access network (E-UTRAN) Core Network Entities like AMF/SMF/MME/UPF or the Network could be any 5G/E-UTRAN RAN Entity like eNodeB (eNB) or gNodeB (gNB) or NG-RAN etc. The messages used or indicated in this embodiment are shown as an example. The messages could be any signaling messages between the UE (102) and the network functions/entities or between different network, functions/entities. The term area/location/geographical area are used in this embodiment may refer to any of cell/cell ID, TAC/TAI, PLMN, MCC/MNC, Latitude/longitude, closed access group (CAG) cell or any geographical location/coordinate. The methods, issues or solutions disclosed in this embodiment are explained using NR access or NG-RAN Access Technology as an example and is not restricted or limited to NR access only. However, the solutions proposed in this embodiment are also applicable for E-UTRAN access Technology, Narrow Band (NB)-S1 mode or Wide Band (WB)-S1 mode via E-UTRAN access and/or Narrowband Internet Of Things (NB-IoT) or Wideband Internet Of Things (WB-IoT) Access/Architecture. The solutions which are defined for NR (5GC) are also applicable to legacy RATs like E-UTRA/LTE, the corresponding CN entities needs to be replaced by LTE entities for e.g. AMF with MME, g-nodeB with e-nodeB, unified data management (UDM) with home subscriber server (HSS) etc. But principles of the solution remains same.

The terms camp and register are used interchangeably and have the same meaning. The terms wait timer, DisCo wait timer, Discontinuous Coverage wait timer, Random timer, Random wait timer, DCW Timer are all used interchangeably and have the same meaning. The terms wait range, Disco Wait Range, Discontinuous Coverage Wait Range, DCW Range are all used interchangeably and have the same meaning. The term area as used in this embodiment may refer to any of cell/cell ID, TAC/TAI, PLMN, MCC/MNC, Latitude/longitude, any CAG/CAG identifier or any geographical location/coordinate. For the list of possible NAS messages please refer to 3GPP TS 24.501 or 3GPP TS 24.301, for list of AS messages please refer to 3GPP TS 38.331 or 3GPP TS 36.331. The cause names in this embodiment are for illustration purpose and it can have any name. The non-access stratum (NAS) messages and access stratum (AS) messages described in this embodiment is only for illustration purpose it can be any NAS or AS messages as per defined protocol between UE and AMF/MME or UE and gNB (NG-RAN/any RAN node)/eNB.

In an embodiment, the term satellite is used interchangeably with 5G or 4G system with satellite access and is used to represent any Satellite(s) or constellation of Satellites(s) or any aerial body/satellite in any of the Satellite orbits (for ex-LEO/MEO/GEO/HEO etc) or any 5G system with Satellite Access or 4G System with Satellite Access or any RAN Entity or Core Network Entity or any Network Function(s) associated with the Satellite Access/RAT/PLMN/Network. The terms MME/AMF-On-board and MME/AMF-lighter are used interchangeably in this embodiment and have the same meaning. The terms SAT and Satellite are used interchangeably in this embodiment and have the same meaning.

Serving satellite: a satellite providing the satellite access to a UE. In the case of Non-Geostationary Satellite Orbit (NGSO), the serving satellite is always changing due to the nature of the constellation.

Store & Forward Satellite operation: in the context of this study, it is an operation mode of a 4G or 5G system with satellite-access where the 4G or 5G system can provide some level of service (in storing and forwarding the data) when satellite connectivity is intermittently/temporarily unavailable, e.g. to provide communication service for UEs under satellite coverage without a simultaneous active feeder link connection to the ground segment.

S&F data retention period: it is the data storage validity period for the 4G or 5G system with satellite access supporting store and forward operation (e.g. after which undelivered data stored is being discarded).

UE-Satellite-UE Communication: for the 4G or 5G system with satellite access, it refers to the communication between UEs under the coverage of one or more serving satellites, using satellite access without going through the ground segment.

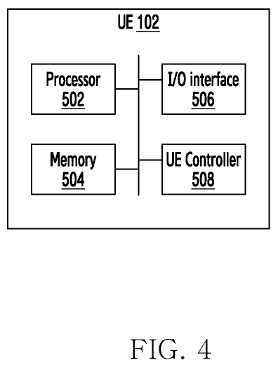

FIG. 4 is a block diagram that illustrates a schematic of the UE (102) implemented to carry out the disclosed subject matter according to an embodiment of the disclosure.

Referring to FIG. 4, the UE (102) may include, but not limited to a smartphone, tablet, personal computer (PC), laptop, an IoT device, and the like. As shown, the UE (102) includes a processor (502), memory (504), an input/output (I/O) interface (506), and a UE controller (508). Each component is explained in further detail below.

The processor (502) communicates with the memory (504), the I/O interface (506) and the UE controller (508). The processor (502) is configured to execute instructions stored in the memory (504) and to perform various processes. The processor (502) may include one or a plurality of processors, may be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The memory (504) includes storage locations to be addressable through the processor (502). The memory (504) is not limited to volatile memory and/or non-volatile memory. Further, the memory (504) may include a plurality of computer-readable storage media. The memory (504) may include non-volatile storage elements. For example, non-volatile storage elements may include magnetic hard disks, optical discs, floppy disks, flash memories, or forms of electrically programmable read only memory (EPROM) or electrically erasable and programmable ROM (EEPROM) memories.

The I/O interface (506) transmits the information between the memory (504) and external peripheral devices. The peripheral devices are the input-output devices associated with the UE (102). Further, the UE controller (508) communicates with the I/O interface (506) and the memory (504). The UE controller (508) may be communicatively coupled to the memory (504) and the processor (502). The UE controller (508) is an innovative hardware that is realized through the physical implementation of both analog and digital circuits, including logic gates, integrated circuits, microprocessors, microcontrollers, memory circuits, passive and active electronic components, as well as optical components.

In an embodiment, the UE controller (508) detects whether a service link is available between the UE (102) and the first network apparatus (202) associated with the satellite (108). The service link refers to a logical connection that carries data traffic. The service link may be established through protocol layers and connections between the UE (102) and the first network apparatus (202), enabling communication with the internet or other services. For example, the service link may be established through a protocol data unit (PDU) session. This session allows the UE (102) to send and receive data to and from the first network apparatus (202).

In an embodiment, the UE controller (508) generates a signaling to be transmitted to the first network apparatus when the service link is available between the UE and the first network apparatus. For example, the signaling may include a non-access stratum (NAS) message, an access stratum (AS) message, a NAS signal, an AS signal, a control plane message, a user plane message, an application data and the like.

In an embodiment, the UE controller (508) receives a response to the signaling transmitted from a third network apparatus (206) associated with the satellite (108). This response may be received when the service link is available between the UE (102) and the third network apparatus (206). For example, the third network apparatus (206) may refer to an AMF/MME on-board a satellite (108) or any other satellite other than the satellite (108).

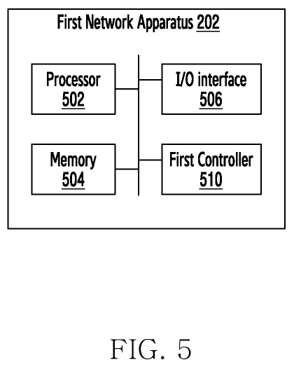

FIG. 5 is a block diagram that illustrates a schematic of the first network apparatus (202) implemented to carry out the disclosed subject matter according to an embodiment of the disclosure.

Referring to FIG. 5, the first network apparatus (202) may refer to an AMF/MME on-board the satellite (108). As shown, the first network apparatus (202) includes the processor (502), the memory (504), the I/O interface (506), and a first controller (510). The first controller (510) communicates with the I/O interface (506) and the memory (504). The first controller (510) may be communicatively coupled to the memory (504) and the processor (502). The first controller (510) is an innovative hardware that is realized through the physical implementation of both analog and digital circuits, including logic gates, integrated circuits, microprocessors, microcontrollers, memory circuits, passive and active electronic components, as well as optical components.

In an embodiment, the first controller (510) receives a signaling from the UE (102) to initiate an attach procedure or a registration procedure. The attach/registration procedure establishes a connection between the UE (102) and the first network apparatus (202) for the first time or when the UE (102) reconnects after a loss of connection. For instance, the signaling may include a NAS message, an AS message, a NAS signal, an AS signal, a control plane message, a user plane message, and application data and the like.

The NAS messages are part of the control plane signaling between the UE (102) and the first network apparatus (202) and between the UE and the second network apparatus (204). The NAS message is responsible for functions like mobility management, session management, and authentication. The NAS messages manage the connection between the UE (102) and the first network apparatus (202) and between the UE and the second network apparatus (204), handling tasks such as attach, tracking area update, registration, Mobility registration update, authentication, session management, location update, and the like. The AS messages are used to manage radio resources, handovers, and low-level signaling related to the air interface. The AS message handle the radio link, including one or more tasks such as radio resource control (RRC), handover, radio bearer management, and the like.

The NAS signals refer to the control plane signaling messages sent over the NAS layer between the UE (102) and the first network apparatus (202) and between the UE and the second network apparatus (204). The NAS signals are used for tasks like mobility management, session management, and security-related procedures. The NAS signals enable the coordination between the UE (102) and the first network apparatus (202) for connection setup, authentication, and mobility. The AS signals refer to the control plane signaling messages sent over the AS layer between the UE (102) and the first network apparatus (202). The AS messages manage the radio link, handover processes, and other air-interface related tasks. Further, the control plane messages are used for signaling purposes (e.g., management, setup, and control) rather than carrying user data. The control plane messages handle the exchange of information required to establish and maintain a connection between the UE (102) and the first network apparatus (202).

Further, the signaling sent by the UE (102) includes a UE identifier and a UE location identifier. The UE identifier is a unique identifier that helps the first network apparatus (202) recognize and manage the UE (102). For instance, the UE identifier may include an international mobile subscriber identity (IMSI), a globally unique temporary identifier (GUTI), a 5G globally unique temporary identifier (5G-GUTI), an international mobile equipment identity (IMEI), and the like. The UE location identifier is used by the first network apparatus (202) to track the physical, geographical or logical location such as co-ordinates of the UE (102) within the 5G or 4G network. The first network apparatus (202) needs to know where the UE (102) is located to deliver services, deliver message/signaling or data, manage mobility, and handle handovers between cells or regions. The UE location identifier may be the current location of the UE or the expected future location of the UE at a later point of time.

In an embodiment, the first controller (510) determines whether a feeder link is available between the first network apparatus (202) and the second network apparatus (204) associated with the ground network (104). The feeder link is used to transmit signals between the ground network (104) and the satellite (108) in orbit. The satellite (108) then relays the signals to the UE (102) or other ground stations. For example, the feeder link may include an uplink feeder link and a downlink feeder link.

In an embodiment, the first controller (510) transmits the signaling received from the UE (102) to the second network apparatus (204) when the feeder link is available between the first network apparatus (202) and the second network apparatus (204). If the feeder link is not available between the first network apparatus (202) and the second network apparatus (204), then the first controller (510) stores the signaling received. The first controller (510) transmits the signaling to the second network apparatus (204) only if the feeder link is available. This prevents the first network apparatus (202) in sending multiple attach or registration requests to the second network apparatus (204).

In an embodiment, the first controller (510) receives a response signaling from the second network apparatus (204) upon transmission of the signaling from the first network apparatus (202). The response signaling may be received when the feeder link is available between the second network apparatus (204) and the third network apparatus (206). The third network apparatus (206) stores the response signaling received from the second network apparatus (204). For instance, the response signaling may include an attach accept message or an attach reject message or registration accept message or registration reject message.

The attach accept message or the registration accept message informs the UE (102) that it has successfully registered with the second network apparatus (204) and can start using network services. The attach accept message or registration accept message may include details about tracking areas, session management information, access restrictions, and network slices the UE (102) is allowed to use. Further, the attach reject message or registration reject message informs the UE (102) that its attempt to register with the second network apparatus (204) has failed. The attach reject message includes a cause value that indicates the reason for the failure. For example, the failure reasons may include authentication failure, access denied, network congestion, and the like.

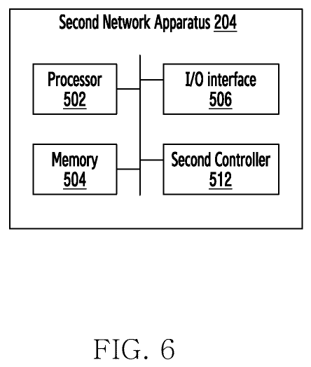

FIG. 6 is a block diagram that illustrates a schematic of the second network apparatus (204) implemented to carry out the disclosed subject matter according to an embodiment of the disclosure.

Referring to FIG. 6, the second network apparatus (204) may refer to an AMF/MME on-board the ground network (104). As shown, the second network apparatus (204) includes the processor (502), the memory (504), the I/O interface (506), and a second controller (512). The second controller (512) communicates with the I/O interface (506) and the memory (504). The second controller (512) may be communicatively coupled to the memory (504) and the processor (502). The second controller (512) is an innovative hardware that is realized through the physical implementation of both analog and digital circuits, including logic gates, integrated circuits, microprocessors, microcontrollers, memory circuits, passive and active electronic components, as well as optical components.

In an embodiment, the second controller (512) receives a signaling from the first network apparatus (202) associated with the satellite (108) when a feeder link is available between the first network apparatus (202) and the second network apparatus (204). For example, the signaling may include a NAS message, an AS message, a NAS signal, an AS signal, a control plane message, a user plane message, and application data and the like. The feeder link transmits signals between the ground network (104) and the satellite (108) in orbit. The satellite (108) subsequently transmits the signals to the UE (102) or other ground stations. The second controller (512) then stores the signal received from the first network apparatus (202).

In an embodiment, the second controller (512) determines the third network apparatus (206) associated with the satellite (108) to transmit a response signaling to the UE (102) upon receiving the signaling using the first network apparatus (202) based on an expected location of the UE (102). For instance, the first network apparatus (202) and third network apparatus (206) may be a same network apparatus or a different network apparatus.

If the first network apparatus (202) is far or not near to the expected location of the UE (102), then it may not be able to establish communication with the UE (102). That is where the requirement of the third network apparatus (206) is necessary. In case the third network apparatus (206) is also far or not near to the expected location of the UE (102), then the second controller (512) determines other network apparatuses associated with associated with a satellite other than the satellite (108). For instance, the other network apparatuses may correspond to AMFs/MMEs on-board other satellites, different than the satellite (108). Thus, the solution disclosed is capable in choosing the best satellite(s) and network apparatus associated with that satellite for establishing communication with the UE (102), based on the current or expected location of the UE (102). This thus prevents connection losses or network disturbances.

The second controller (512) determines the third network apparatus (206) based on a plurality of parameters. For instance, the plurality of parameters may include a rotation information, an ephemeris information, and a satellite coverage availability information (SCAI). The rotation information refers to data about the rotation of a satellite or celestial body, including its orientation and the rate at which it rotates. This information is essential for predicting the position of a satellite's communication antennas or instruments and ensuring that they remain properly aligned with the ground network (104) and the UE (102). The rotation information may help optimize the connection between the satellite (108) and the ground network (104) or the UE (102), ensuring consistent coverage and link quality.

The ephemeris information provides the precise position and velocity data of a satellite (or any other celestial object) over a specific period of time. The ephemeris information includes the satellite's orbital parameters, allowing the second controller (512) to calculate the satellite's current and future positions. Ephemeris information helps the second controller (512) predict when satellites will be in range, enabling seamless handovers, optimized coverage, and uninterrupted communication. Further, the SCAI is data that provides insight into where and when satellites have coverage over a specific area on the earth. The SCAI includes details on the geographical areas (footprints) satellites can service, along with the time periods when coverage will be available. SCAI helps manage connectivity by determining which satellites will be available to provide service in specific regions at particular times. This ensures that users in remote or underserved areas can maintain connectivity as satellites move in and out of range.

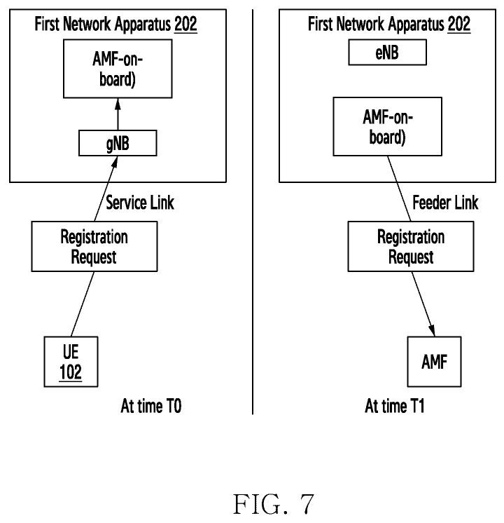

FIG. 7 is a block diagram that illustrates a 4G or 5G satellite architecture with split AMF according to an embodiment of the disclosure.

Referring to FIG. 7, at time T0, the service link is established between the UE (102) and the first network apparatus (202) on the satellite (108). At time T1, the feeder link is operational between the first network apparatus (202) and the AMF (located on the ground network (104)). The satellite (108) has AMF or any other network function to enable the S&F registration operation. The AMF or any other network function (NF) may be fully functional or a simplified version of the NF with the capabilities needed to conduct the registration operation on board.

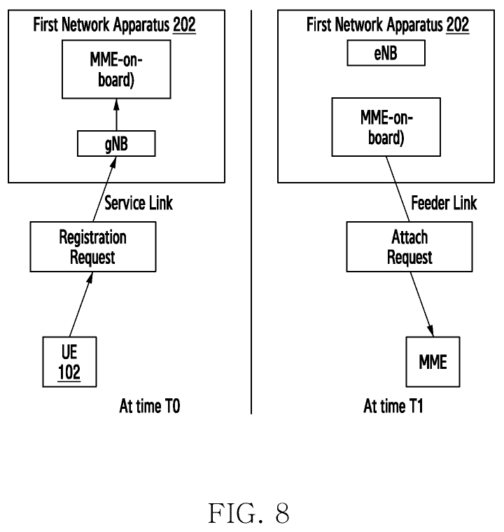

FIG. 8 is a block diagram that illustrates a 4G satellite architecture with split MME according to an embodiment of the disclosure.

Referring to FIG. 8, at time T0, the service link is established between the UE (102) and the first network apparatus (202) on the satellite (108). At time T1, the feeder link is operational between the first network apparatus (202) and the MME (located on the ground network (104)). The satellite (108) has MME or any other network function to enable the S&F registration operation. The MME or any other CN entity onboard the satellite may be fully functional or a simplified version of the CN Entity with the capabilities needed to conduct the attach operation on board.

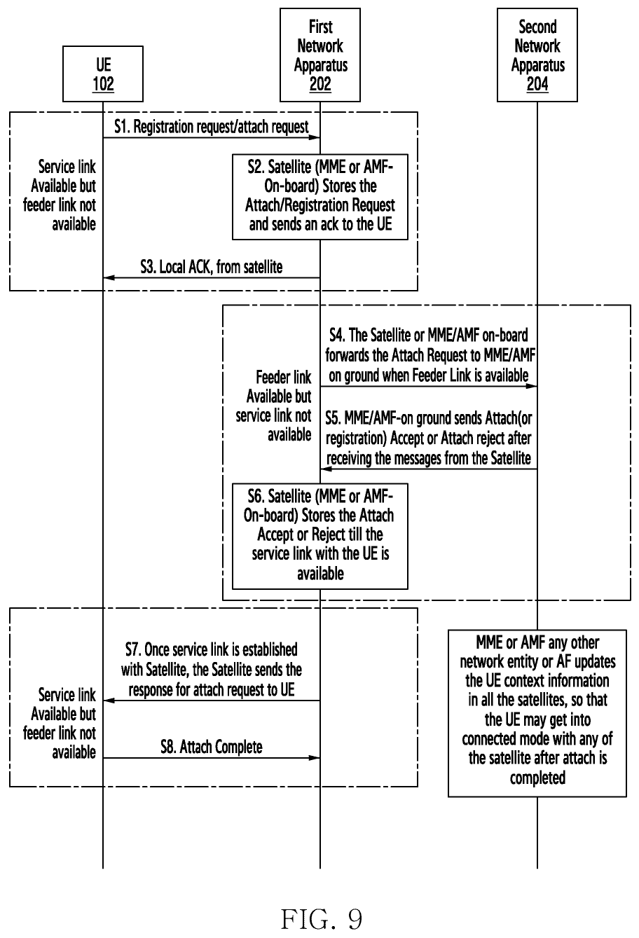

FIG. 9 is a sequence diagram that illustrates a registration/attach and uplink procedure according to an embodiment of the disclosure.

As shown in the sequence diagram, the UE (102), the first network apparatus (202), and the second network apparatus (204) are in communication with each other. The first network apparatus (202) may correspond to an MME/AMF on-board the satellite (108). The second network apparatus (204) may correspond to an MME/AMF on-board the ground network (104).

At step S1, the UE (102) sends the attach request or registration request or any other NAS/AS signaling the first network apparatus (202) on-board the satellite (108) operating in the S&F mode. At step S2, the first network apparatus (202) on-board the satellite (108) stores the attach request/registration request received from the UE (102). At step S3, the first network apparatus (202) on-board the satellite (108) sends an acknowledgement to the UE (102) upon receiving and storing the attach request/registration request from the UE (102). The acknowledgement may be a lower layer acknowledgement or any NAS message or AS message indicating receipt of the attach request. At step S4, when the feeder link is established between the first network apparatus (202) on-board the satellite (108) and the second network apparatus (204) on-board the ground network (104), the first network apparatus (202) on-board the satellite (108) transmits the stored attach request/registration request to the second network apparatus (204) on-board the ground network (104).

At step S5, the second network apparatus (204) on-board the ground network (104) sends a response (attach/registration Accept or attach/registration Reject) to the first network apparatus (202) on-board the satellite (108) upon receiving the stored attach request/registration request. At step S6, the first network apparatus (202) on-board the satellite (108) stores the response until the service link with the UE (102) is available. At step S7, once the service link is established, the first network apparatus (202) on-board the satellite (108) sends the response to the UE (102). At step S8, the UE (102) sends an attach complete/registration complete message to the first network apparatus (202) on-board the satellite (108) upon successful receiving of the response.

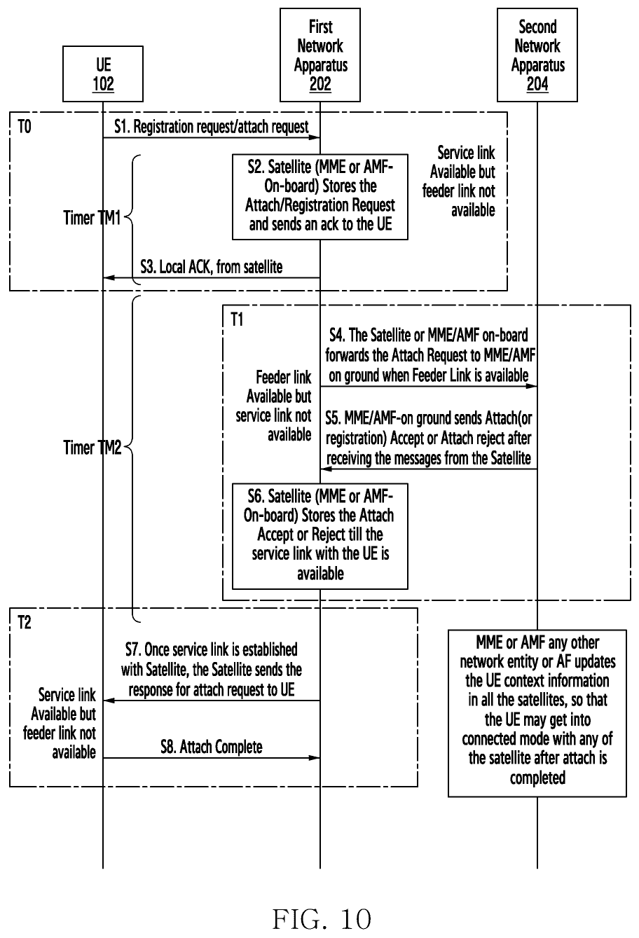

FIG. 10 is a sequence diagram that illustrates the registration and uplink procedure using timers according to an embodiment of the disclosure.

Referring to FIG. 10, the UE (102), the first network apparatus (202), and the second network apparatus (204) are in communication with each other. The first network apparatus (202) may correspond to a MME/AMF on-board the satellite (108). The second network apparatus (204) may correspond to a MME/AMF on-board the ground network (104).

At step S1, the UE (102) sends the attach request or registration request or any other NAS/AS signaling to the first network apparatus (202) on-board the satellite (108) operating in the S&F mode. At step S2, the first network apparatus (202) on-board the satellite (108) stores the attach request/registration request received from the UE (102). At step S3, the first network apparatus (202) on-board the satellite (108) sends an acknowledgement to the UE (102) upon receiving and storing the attach request/registration request from the UE (102). At step S4, when the feeder link is established between the first network apparatus (202) on-board the satellite (108) and the second network apparatus (204) on-board the ground network (104), the first network apparatus (202) on-board the satellite (108) transmits the stored attach request/registration request to the second network apparatus (204) on-board the ground network (104).

At step S5, the second network apparatus (204) on-board the ground network (104) sends a response (attach/registration Accept or attach/registration Reject) to the first network apparatus (202) on-board the satellite (108) upon receiving the stored attach request/registration request. At step S6, the first network apparatus (202) on-board the satellite (108) stores the response until the service link with the UE (102) is available. At step S7, once the service link is established, the first network apparatus (202) on-board the satellite (108) sends the response to the UE (102). At step S8, the UE (102) sends an attach complete message to the first network apparatus (202) on-board the satellite (108) upon successful receiving of the response.

When the UE (102) transmits the attach request or registration request or any other NAS/AS signaling to the first network apparatus (202) on-board the satellite (108), it initiates a timer (e.g., Tm1) to await acknowledgement from the first network apparatus (202). The first network apparatus (202) transmits an acknowledgement to the UE (102) after receiving and storing the attach request (or any other message or signaling) from the UE (102). If the UE (102) does not get an acknowledgement from the first network apparatus (202) within timer Tm1, it resends the attach or registration request to the first network apparatus (202). When the UE (102) receives the acknowledgement, it begins another timer (such as timer Tm2).

The UE (102) awaits the response (attach accept or attach reject) or any other NAS communication from the second network apparatus (204) on the ground network (104) in response to the attach request/registration request. When the UE (102) receives the response message/signal for the attach/registration request or any other signaling, it pauses the timer Tm2.

The UE may additionally run a timer (e.g., Tm3) that is equal to the total of Tm1 and Tm2 values. The round-trip time (RTT) between the UE (102) and the second network apparatus (204) will be determined by the availability of the feeder link and whether the response is delivered from the first network apparatus (202) on the same satellite (satellite (108) from which the attach request was received, or via a different satellite. The timer should take the largest feasible value from the aforementioned values such that the UE (102) does not disregard the previous attach request and does not try a new attach request. Further, the first network apparatus (202) transmits the estimated RTT from the second network apparatus (204) to the UE (102). The UE (102) updates its timer settings based on the RTT/expected response time obtained from the first network apparatus (202).

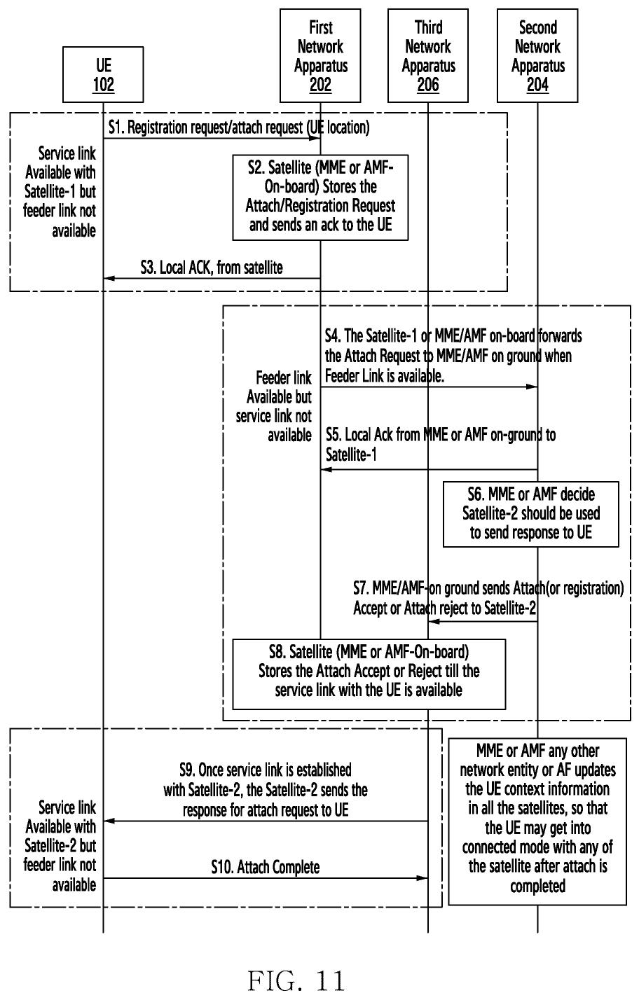

FIG. 11 is a sequence diagram that illustrates the registration and uplink procedure between two satellites according to an embodiment of the disclosure.

As shown in the sequence diagram, the UE (102), the first network apparatus (202), the second network apparatus (204), and the third network apparatus (206) are in communication with each other. The first network apparatus (202) may correspond to a MME/AMF on-board the satellite (108) (satellite-1). The second network apparatus (204) may correspond to a MME/AMF on-board the ground network (104). The third network apparatus (206) may correspond to a MME/AMF on-board another satellite (satellite-2).

At step S1, the UE (102) sends the attach request or registration request (including the current or expected future location of the UE (102)) or any other NAS/AS signaling to the first network apparatus (202) on-board the satellite (108) operating in the S&F mode. At step S2, the first network apparatus (202) on-board the satellite (108) stores the attach request/registration request received from the UE (102). At step S3, the first network apparatus (202) on-board the satellite (108) sends an acknowledgement to the UE (102) upon receiving and storing the attach request/registration request from the UE (102). At step S4, the first network apparatus (202) on-board the satellite (108) forwards the attach request to the second network apparatus (204) on-board the ground network (104) when the feeder link is available. At step S5, the second network apparatus (204) on-board the ground network (104) sends an acknowledgment to the first network apparatus (202) on-board the satellite (108) upon receiving the attach request.

At step S6, the first network apparatus (202) on-board the satellite (108) decides to send the response of the received attach/registration request or any other NAS/AS signaling via a different satellite (satellite-2). The second network apparatus (204) on-board the ground network (104) sends the response and the third network apparatus (206) on-board the satellite-2 stores the response received from the second network apparatus (204) on-board the ground network (104) when the feeder link is available. At step S7, the second network apparatus (204) on-board the ground network (104) shares the response to the third network apparatus (206) on-board the satellite-2. At step S8, the third network apparatus (206) on-board the satellite-2 stores response until the service link with the UE (102) is available.

At step S9, when the satellite-2 reaches the location where the service link with the UE (102) can be established, the third network apparatus (206) on-board the satellite-2 delivers the response message/signal to the UE (102). At step S10, the UE (102) sends an attach complete message or any other NAS/AS signaling to the third network apparatus (206) on-board the satellite-2 once the response has been received. The UE (102) should notify the second network apparatus (204) of its current location or next expected position or the next satellite expected to offer service to it. The second network apparatus (204) should compute the next satellite serving the UE (102) so that the answer or other messages can be sent to the UE (102) in the shortest feasible time. For example, satellite rotation information, ephemeris information, coverage information over time, and the like may be shared with the second network apparatus (204) so that it can correctly determine the next serving satellite for the UE (102) and send the response to the UE (102) in the shortest amount of time.

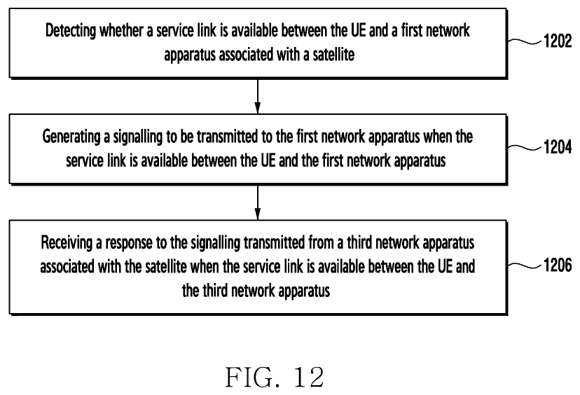

FIG. 12 is a flow chart that illustrate a method for performing signaling using satellite access in a 5G or 4G network by a UE according to an embodiment of the disclosure. The method includes operations 1202-1206. Each step is explained in further detail below.

Referring to FIG. 12, at operation 1202, the UE (102) detects whether a service link is available between the UE (102) and the first network apparatus (202) associated with the satellite (108). The service link is a logical connection that transmits data traffic. The service link may be built using protocol layers and connections between the UE (102) and the first network apparatus (202) to allow communication with the internet or other services. For example, the service link might be formed via a protocol data unit (PDU) session. This session enables the UE (102) to transmit and receive data from the first network apparatus (202).

At operation 1204, the UE (102) generates a signaling to be transmitted to the first network apparatus when the service link is available between the UE and the first network apparatus. For example, the signaling may include a non-access stratum (NAS) message, an access stratum (AS) message, a NAS signal, an AS signal, a control plane message, a user plane message, an application data and the like.

At operation 1206, the UE (102) receives a response to the signaling transmitted from a third network apparatus (206) associated with the satellite (108). This response may be received if a service link exists between the UE (102) and the third network apparatus (206). For example, the third network apparatus (206) might correspond to an AMF/MME on a satellite different than the satellite (108).

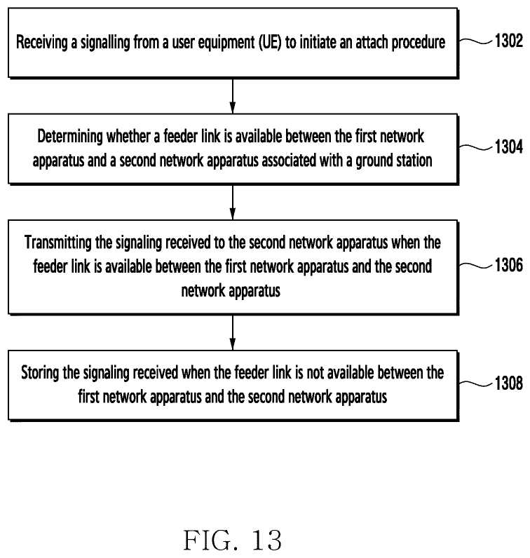

FIG. 13 is a flow chart that illustrate a method for performing signaling using satellite access in a 4G or 5G network by a first network apparatus according to an embodiment of the disclosure. The method includes operations 1302-1308. Each step is explained in further detail below.

Referring to FIG. 13, at operation 1302, the first network apparatus (202) receives a signaling from the UE (102) to initiate an attach procedure or a registration procedure or any other NAS/AS signaling. The attach/registration procedure connects the UE (102) to the first network apparatus (202) for the first time or when the UE (102) reconnects following a loss of connection. For instance, the signaling may include a NAS message, an AS message, a NAS signal, an AS signal, a control plane message, a user plane message, and the like.

The NAS messages form part of the control plane communication between the UE (102) and the first network apparatus (202). The NAS message handles operations such as mobility management, session management, and authentication. The NAS messages control the connection between the UE (102) and the first network apparatus (202), performing functions such as registration, authentication, session management, location updates, and so on. AS messages are used to manage radio resources, handovers, and low-level air interface signaling. The AS message manages the radio link by performing one or more activities such as radio resource control (RRC), handover, radio bearer management, and the like.

The NAS signals are control plane signaling messages delivered over the NAS layer between the UE (102) and the first network apparatus (202). The NAS signals are utilized for duties like as mobility management, session management, and security protocols. The NAS signals enable the UE (102) and the first network apparatus (202) to coordinate connection establishment, authentication, and mobility. The AS signals are control plane signaling messages delivered over the AS layer between the UE (102) and the first network apparatus (202). The AS messages control the radio connection, handover procedures, and other air-interface activities. Furthermore, control plane communications are utilized for signaling (administration, setup, and control) rather than delivering user data. The control plane messages facilitate the exchange of information needed to establish and maintain a connection between the UE (102) and the first network apparatus (202).

Further, the UE (102) sends signals that contains a UE identifier and a UE location identifier. The UE identifier is a unique identifier that allows the first network apparatus (202) to detect and control the UE (102). For example, the UE identifier might contain an international mobile subscriber identity (IMSI), a globally unique temporary identifier (GUTI), a 5G globally unique temporary identifier (5G-GUTI), an international mobile equipment identity (IMEI), and so on. The first network apparatus (202) uses the UE location identifier to track the physical or logical location of the UE (102) inside the 4G or 5G network. The first network apparatus (202) needs to know the location of the UE (102) in order to provide services, control mobility, and handle handovers between cells or regions.

At operation 1304, the first network apparatus (202) determines whether a feeder link is available between the first network apparatus (202) and the second network apparatus (204) associated with the ground network (104). The feeder link transmits signals between the ground network (104) and the satellite (108) in orbit. The satellite (108) subsequently transmits the signals to the UE (102) or other ground stations. For example, the feeder link may consist of an uplink and a downlink feeder link.

At operation 1306, the first network apparatus (202) transmits the signaling received from the UE (102) to the second network apparatus (204) when the feeder link is available between the first network apparatus (202) and the second network apparatus (204).

At operation 1308, if there is no feeder link between the first network apparatus (202) and the second network apparatus (204), the first network apparatus (202) saves the signals received. Only when the feeder connection is accessible does the first network apparatus (202) broadcast the signals to the second network apparatus (204). This prohibits the first network apparatus (202) from submitting numerous attach or registration requests to the second network apparatus (204).

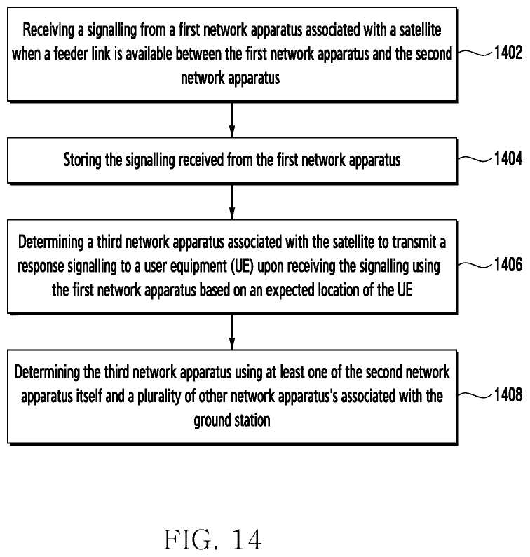

FIG. 14 is a flow chart that illustrate a method for performing signaling using satellite access in a 4G or 5G network by a second network apparatus according to an embodiment of the disclosure. The method includes operations 1402-1408. Each step is explained in further detail below.

Referring to FIG. 14, at operation 1402, the second network apparatus (204) receives a signaling from the first network apparatus (202) associated with the satellite (108) when a feeder link is available between the first network apparatus (202) and the second network apparatus (204). For example, the signaling may include a NAS message, an AS message, a NAS signal, an AS signal, a control plane message, a user plane message, and the like. The feeder link transfers signals from the ground network (104) to the satellite (108) in orbit. The satellite (108) then sends the signals to the UE (102) or other ground stations.

At operation 1404, the second network apparatus (204) then stores the signaling received from the first network apparatus (202) at operation 1402.

At operation 1406, the second network apparatus (204) determines the third network apparatus (206) associated with the satellite (108) to transmit a response signaling to the UE (102) upon receiving the signaling using the first network apparatus (202) based on current location of the UE or an expected location of the UE (102). For instance, the first network apparatus (202) and third network apparatus (206) may be a same network apparatus or a different network apparatus. If the first network apparatus (202) is far or not near to the expected location of the UE (102), then it may not be able to establish communication with the UE (102). That is where the requirement of the third network apparatus (206) is necessary.

The second network apparatus (204) determines the third network apparatus (206) based on a plurality of parameters. For instance, the plurality of parameters may include a rotation information, an ephemeris information, and a satellite coverage availability information (SCAI). Rotation information is data concerning the rotation of a satellite or celestial body, such as its direction and rate of rotation. This data is critical for anticipating the location of a satellite's communication antennae or sensors and ensuring that they remain in good alignment with the terrestrial network (104) and the UE (102). The rotation information may aid in optimizing the connection between the satellite (108) and the ground network (104) or the UE (102), guaranteeing consistent coverage and link quality.

The ephemeris information offers exact location and velocity data for a satellite (or any other celestial object) during a set period of time. The ephemeris information provides the satellite's orbital characteristics, which enable the second network apparatus (204) to determine the satellite's present and future locations. The second network apparatus (204) uses ephemeris information to estimate when satellites will be in range, allowing for smooth handovers, optimal coverage, and uninterrupted communication. Further, SCAI data offers information on where and when satellites cover a given area of the world. The SCAI comprises information on the geographical areas (footprints) that satellites can service, as well as the times when coverage will be available. SCAI facilitates connection management by identifying which satellites will be accessible to offer service in specified locations at given times. This guarantees that consumers in rural or underserved locations may stay connected when satellites pass in and out of range.

At operation 1408, in case the third network apparatus (206) is also far or not near to the expected location of the UE (102), then the second network apparatus (204) determines other network apparatuses associated with the ground network (104). For instance, the other network apparatuses may correspond to AMFs/MMEs on-board other satellites, different than the satellite (108). Thus, the solution disclosed is capable in choosing the best satellite(s) for establishing communication with the UE (102), based on the expected location of the UE (102). This thus prevents connection losses or network disturbances.

According to an embodiment, a first network node may correspond to the first network apparatus (202) (or a third network apparatus (206)). The first network node may be related to the NTN. The first network node may be provided by a device related to a satellite. According to an embodiment, the first network node may be implemented as a device located in the air, for providing communication between UE and a second network node. For example, the first network node can be implemented as a non-terrestrial base station included in a satellite or air transport device. The first network node may relay communication between the UE and the second network node.

According to an embodiment, a second network node may correspond to the second network apparatus (204). The second network node may be related to the TN. The second network node may be provided by a device related to a ground network. According to an embodiment, the second network node may be implemented as a device located on the ground. For example, the second network node can be implemented as a terrestrial base station.

According to an embodiment, a method performed by a user equipment (UE) for performing signalling using satellite access in a 4th generation (4G) or 5th generation (5G) network, comprises detecting, by the UE, whether a service link is available between the UE and a first network apparatus associated with a satellite, generating, by the UE, a signal to be transmitted to the first network apparatus when the service link is available between the UE and the first network apparatus, and receiving, by the UE, a response to the signal transmitted from a third network apparatus associated with the satellite when the service link is available between the UE and the third network apparatus.

For example, a method performed by a first network apparatus for performing signalling using satellite access in a 4th generation (4G) or 5th generation (5G) network, comprises receiving, by the first network apparatus associated with a satellite, a signal from a user equipment (UE) to initiate an attach procedure, determining, by the first network apparatus, whether a feeder link is available between the first network apparatus and a second network apparatus associated with a ground network, and performing, by the first network apparatus, one of transmitting, by the first network apparatus, the signaling received to the second network apparatus when the feeder link is available between the first network apparatus and the second network apparatus, or storing, by the first network apparatus, the signaling received when the feeder link is not available between the first network apparatus and the second network apparatus.

For example, the signal comprises at least one of a non-access stratum (NAS) message, an access stratum (AS) message, a NAS signal, an AS signal, a control plane message, a user plane message, or an application data.

For example, the signal sent by the UE comprises at least one of a UE identifier or a UE location identifier.

For example, the method comprises receiving, by a third network apparatus, a response signal from a second network apparatus upon transmission of the signal from the first network apparatus when the feeder link is available between the second network apparatus and the third network apparatus. The third network apparatus stores the response signal received from the second network apparatus.

For example, the first network apparatus associated with the satellite comprises at least one of a next generation node B (gNB), an evolved node B (eNB), an access and mobility management function (AMF), a mobility management entity (MME), a session management function (SMF), a serving gateway (S-GW), a packet data network gateway (P-GW), a user plane function (UPF), a policy control function (PCF), a network exposure function (NEF), or a proxy data network (Proxy-DN).

According to an embodiment, a method performed by a second network apparatus for performing signal using satellite access in a 4th generation (4G) or 5th generation (5G) network, comprises receiving, by the second network apparatus associated with a ground network, a signal from a first network apparatus associated with a satellite when a feeder link is available between the first network apparatus and the second network apparatus, storing, by the second network apparatus, the signal received from the first network apparatus, and determining, by the second network apparatus, a third network apparatus associated with the satellite to transmit a response signal to a user equipment (UE) upon receiving the signal using the first network apparatus based on an expected location of the UE.

For example, the second network apparatus associated with the ground network comprises at least one of a next generation node B (gNB), an evolved node B (eNB), an access and mobility management function (AMF), a mobility management entity (MME), a session management function (SMF), a serving gateway (S-GW), a packet data network gateway (P-GW), a user plane function (UPF), a policy control function (PCF), a network exposure function (NEF), or a proxy data network (Proxy-DN).

For example, the determining, by the second network apparatus, of the third network apparatus associated with the satellite to transmit a response signal to the UE upon receiving the signal using the first network apparatus based on an expected location of the UE comprises determining, by the second network apparatus, the third network apparatus using at least one of the second network apparatus or a plurality of other network apparatuses associated with the ground network.

For example, the second network apparatus determines the third network apparatus using a plurality of parameters.

For example, the plurality of parameters comprise at least one of a rotation information, an ephemeris information, or a satellite coverage availability information (SCAI). A location identifier is provided by the UE.

For example, the first network apparatus and third network apparatus is a same network apparatus or a different network apparatus.

For example, the second network apparatus stores the response signal to the signal by the first network apparatus until at least one third network apparatus of the plurality of other network apparatuses associated with a satellite is determined.

According to an embodiment, A user equipment (UE) for performing signal using satellite access in a 4th generation (4G) or 5th generation (5G) network, comprises memory, one or more processors coupled to the memory, and a UE controller communicatively coupled to the memory and the one or more processors. The UE controller is configured to detect whether a service link is available between the UE and a first network apparatus associated with a satellite, generate a signal to be transmitted to the first network apparatus when the service link is available between the UE and the first network apparatus, and receive a response to the signal transmitted from a third network apparatus associated with the satellite when the service link is available between the UE and the third network apparatus.

According to an embodiment, A first network apparatus for performing signaling using satellite access in a 4th generation (4G) or 5th generation (5G) network, comprises memory, one or more processors coupled to the memory, and a first controller communicatively coupled to the memory and the one or more processors. The first controller is configured to receive a signal from a user equipment (UE) to initiate an attach procedure, determine whether a feeder link is available between the first network apparatus and a second network apparatus associated with a ground network, and perform one of transmitting the signaling received to the second network apparatus when the feeder link is available between the first network apparatus and the second network apparatus, or storing the signaling received when the feeder link is not available between the first network apparatus and the second network apparatus.

For example, the first network apparatus associated with the satellite comprises at least one of a next generation node B (gNB), an evolved node B (eNB), an access and mobility management function (AMF), a mobility management entity (MME), a session management function (SMF), a serving gateway (S-GW), a packet data network gateway (P-GW), a user plane function (UPF), a policy control function (PCF), a network exposure function (NEF), or a proxy data network (Proxy-DN).

For example, the signal comprises at least one of a non-access stratum (NAS) message, an access stratum (AS) message, a NAS signal, an AS signal, a control plane message, or a user plane message.

For example, the signal sent by the UE comprises at least one of a UE identifier or a UE location identifier.

For example, the first controller receives a response signal from the second network apparatus upon transmission of the signal from the first network apparatus when the feeder link is available between the second network apparatus and a third network apparatus. The third network apparatus stores the response signal received from the second network apparatus.

For example, the response signal includes an attach accept message or an attach reject message.

According to an embodiment, a second network apparatus for performing signaling using satellite access in a 4^{th} generation (4G) or 5^{th} generation (5G) network, comprises memory, one or more processors coupled to the memory, and a second controller communicatively coupled to the memory and the one or more processors. The second controller is configured to receive a signal from a first network apparatus associated with a satellite when a feeder link is available between the first network apparatus and the second network apparatus, store the signal received from the first network apparatus, and determine a third network apparatus associated with the satellite to transmit a response signal to a user equipment (UE) upon receiving the signal using the first network apparatus based on an expected location of the UE.

For example, the second network apparatus associated with a ground network comprises at least one of a next generation node B (gNB), an evolved node B (eNB), an access and mobility management function (AMF), a mobility management entity (MME), a session management function (SMF), a serving gateway (S-GW), a packet data network gateway (P-GW), a user plane function (UPF), a policy control function (PCF), a network exposure function (NEF), or a proxy data network (Proxy-DN).

For example, the second controller determines the third network apparatus using at least one of the second network apparatus or a plurality of other network apparatuses associated with the ground network.

For example, the second network apparatus determines the third network apparatus using a plurality of parameters.

For example, the plurality of parameters comprise at least one of a rotation information, an ephemeris information, or a satellite coverage availability information (SCAI).

For example, the first network apparatus and the third network apparatus may be a same network apparatus or a different network apparatus.

For example, the second network apparatus stores the response signal to the signal by the first network apparatus until at least one other network apparatus of a plurality of other network apparatuses is determined.

For example, when the feeder link is established between the first network apparatus on-board the satellite and the second network apparatus on-board a ground network, the first network apparatus on-board the satellite transmits a stored attach request/registration request to the second network apparatus on-board the ground network.

For example, the second network apparatus on-board the ground network sends a response to the first network apparatus on-board the satellite upon receiving the stored attach request/registration request.

For example, the first network apparatus on-board the satellite stores the response until a service link with the UE is available.

According to an embodiment, one or more non-transitory computer-readable storage media store one or more computer programs including computer-executable instructions that, when executed by one or more processors of a user equipment (UE) individually or collectively, cause the UE to perform operations. The operations comprise detecting, by the user equipment (UE), whether a service link is available between the UE and a first network apparatus associated with a satellite, generating, by the UE, a signal to be transmitted to the first network apparatus when the service link is available between the UE and the first network apparatus, and receiving, by the UE, a response to the signal transmitted from a third network apparatus associated with the satellite when the service link is available between the UE and the third network apparatus.

For example, the signal comprises at least one of a non-access stratum (NAS) message, an access stratum (AS) message, a NAS signal, an AS signal, a control plane message, a user plane message, or an application data.

According to an embodiment, a method performed by a device associated with a satellite, for a first network node, comprise receiving, from a user equipment (UE), a first signal including data to initiate an attach procedure with a second network node, determining whether a feeder link is available, the feeder link corresponding to a link between the first network node and the second network node, based on determining the feeder link is available, transmitting the data included in the first signal to the second network node, and based on determining the feeder link is unavailable, storing the data included in the first signal.

For example, each of the first signal and the second signal comprises at least one of a non-access stratum (NAS) message, an access stratum (AS) message, a NAS signal, an AS signal, a control plane message, a user plane message, or an application data.

For example, the first signal comprises at least one of a UE identifier or a UE location identifier.

For example, the method comprises, based on transmitting the data included in the first signal, receiving, from the second network node, a second signal including data with respect to the first signal.

For example, the method comprises transmitting the stored second signal to the UE for the attach procedure.

For example, the first network node comprises at least one of a next generation node B (gNB), an evolved node B (eNB), an access and mobility management function (AMF), a mobility management entity (MME), a session management function (SMF), a serving gateway (S-GW), a packet data network gateway (P-GW), a user plane function (UPF), a policy control function (PCF), a network exposure function (NEF), or a proxy data network (Proxy-DN).

According to an embodiment, a method performed by a second node, comprises receiving, from a first network node, a first signal based on a feeder link is available, the feeder link corresponding to a link between the first network node and the second network node, storing the first signal received from the first network node, and determining, based on expected location of a user equipment (UE), a third network node associated with the satellite to transmit a second signal to a user equipment (UE).

For example, the second network node comprises at least one of a next generation node B (gNB), an evolved node B (eNB), an access and mobility management function (AMF), a mobility management entity (MME), a session management function (SMF), a serving gateway (S-GW), a packet data network gateway (P-GW), a user plane function (UPF), a policy control function (PCF), a network exposure function (NEF), or a proxy data network (Proxy-DN).

For example, the first signal is transmitted by the UE to the first network node and stored in the first network node.

For example, the method comprises determining the third network node using a plurality of parameters comprising at least one of a rotation information, an ephemeris information, or a satellite coverage availability information (SCAI).

According to an embodiment, a device associated with a satellite, for a first network node, comprises a transceiver, memory storing one or more instructions, comprising one or more storage media, and at least one processor comprising processing circuitry. The instructions, when executed by the at least one processor individually or collectively, cause the first network node to receive, from a user equipment (UE), a first signal to initiate an attach procedure with a second network node, determine whether a feeder link is available, the feeder link corresponding to a link between the first network node and the second network node, and based on determining the feeder link is available, receive a second signal with respect to the first signal from a second network node, and based on determining the feeder link is unavailable, store the first signal.

For example, each of the first signal and the second signal comprises at least one of a non-access stratum (NAS) message, an access stratum (AS) message, a NAS signal, an AS signal, a control plane message, a user plane message, or an application data.

For example, the first signal comprises at least one of a UE identifier or a UE location identifier.

For example, the instructions, when executed by the at least one processor individually or collectively, cause the first network node to, based on transmitting the data included in the first signal, receive, from the second network node, a second signal including data with respect to the first signal.

For example, the instructions, when executed by the at least one processor individually or collectively, cause the first network node to determine whether a service link is available, the service link corresponding to a link between the UE and the first network node, in case of that service link is available, based on receiving the second signal, transmit the data included in the second signal, to the UE, and in case of that service link is unavailable, based on receiving the second signal, store the second signal.

For example, the first network node comprises at least one of a next generation node B (gNB), an evolved node B (eNB), an access and mobility management function (AMF), a mobility management entity (MME), a session management function (SMF), a serving gateway (S-GW), a packet data network gateway (P-GW), a user plane function (UPF), a policy control function (PCF), a network exposure function (NEF), or a proxy data network (Proxy-DN).

According to an embodiment, a second network node comprises a transceiver, memory storing one or more instructions, comprising one or more storage media, and at least one processor comprising processing circuitry. The instructions, when executed by the at least one processor individually or collectively, cause the second network node to receive, from a first network node, a first signal based on a feeder link is available, the feeder link corresponding to a link between the first network node and the second network node, store the first signal received from the first network node, and determine, based on expected location of a user equipment (UE), a third network node to transmit a second signal to a user equipment (UE).

For example, the second network node comprises at least one of a next generation node B (gNB), an evolved node B (eNB), an access and mobility management function (AMF), a mobility management entity (MME), a session management function (SMF), a serving gateway (S-GW), a packet data network gateway (P-GW), a user plane function (UPF), a policy control function (PCF), a network exposure function (NEF), or a proxy data network (Proxy-DN).

For example, the first signal is transmitted by the UE to the first network node and stored in the first network node.

For example, the instructions, when executed by the at least one processor individually or collectively, cause the second network node to determine the third network node using a plurality of parameters comprising at least one of a rotation information, an ephemeris information, or a satellite coverage availability information (SCAI).

While the disclosure has been shown and described with reference to various embodiments thereof, it will be understood by those skilled in the art that various changes in form and details may be made therein without departing from the spirit and scope of the disclosure as defined by the appended claims and their equivalents.

For one or more embodiments, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in a random-access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other types of optical storage devices, or magnetic cassettes. Alternatively, it may be stored in a memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

Meanwhile, specific embodiments have been described in the detailed description of the disclosure, but it goes without saying that various modifications are possible without departing from the scope of the disclosure.

What is claimed is:

1. A method performed by a first network node, the method comprising:
receiving, from a user equipment (UE), a first signal including data to initiate an attach procedure with a second network node;
determining whether a feeder link is available, the feeder link corresponding to a link between the first network node and the second network node;
based on determining the feeder link is available, transmitting the data included in the first signal to the second network node; and
based on determining the feeder link is unavailable, storing the data included in the first signal.

2. The method of claim 1, wherein each of the first signal and the second signal comprises at least one of a non-access stratum (NAS) message, an access stratum (AS) message, a NAS signal, an AS signal, a control plane message, a user plane message, or an application data.

3. The method of claim 1, wherein the first signal comprises at least one of a UE identifier or a UE location identifier.

4. The method of claim 1, wherein the method comprises:
based on transmitting the data included in the first signal, receiving, from the second network node, a second signal including data with respect to the first signal.

5. The method of claim 4, wherein the method comprises:
determining whether a service link is available, the service link corresponding to a link between the UE and the first network node,
in case of that service link is available, based on receiving the second signal, transmitting the data included in the second signal, to the UE, and
in case of that service link is unavailable, based on receiving the second signal, storing the second signal.

6. The method of claim 1, wherein the first network node comprises at least one of a next generation node B (gNB), an evolved node B (eNB), an access and mobility management function (AMF), a mobility management entity (MME), a session management function (SMF), a serving gateway (S-GW), a packet data network gateway (P-GW), a user plane function (UPF), a policy control function (PCF), a network exposure function (NEF), or a proxy data network (Proxy-DN).

7. A method performed by a second node, the method comprising:
receiving, from a first network node, a first signal based on a feeder link is available, the feeder link corresponding to a link between the first network node and the second network node;
storing the first signal received from the first network node; and
determining, based on expected location of a user equipment (UE), a third network node to transmit a second signal to a user equipment (UE).

8. The method of claim 7, wherein the second network node comprises at least one of a next generation node B (gNB), an evolved node B (eNB), an access and mobility management function (AMF), a mobility management entity (MME), a session management function (SMF), a serving gateway (S-GW), a packet data network gateway (P-GW), a user plane function (UPF), a policy control function (PCF), a network exposure function (NEF), or a proxy data network (Proxy-DN).

9. The method of claim 7, wherein the first signal is transmitted by the UE to the first network node and stored in the first network node.

10. The method of claim 7, wherein the method comprises:
determining the third network node using a plurality of parameters comprising at least one of a rotation information, an ephemeris information, or a satellite coverage availability information (SCAI).

11. A first network node comprising:
a transceiver;
memory storing one or more instructions, comprising one or more storage media; and
at least one processor comprising processing circuitry,
wherein the instructions, when executed by the at least one processor individually or collectively, cause the first network node to:
receive, from a user equipment (UE), a first signal including data to initiate an attach procedure with a second network node;
determine whether a feeder link is available, the feeder link corresponding to a link between the first network node and the second network node;
based on determining the feeder link is available, transmit the data included in the first signal to the second network node; and
based on determining the feeder link is unavailable, store the data included in the first signal.

12. The first network node of claim 11, wherein each of the first signal and the second signal comprises at least one of a non-access stratum (NAS) message, an access stratum (AS) message, a NAS signal, an AS signal, a control plane message, a user plane message, or an application data.

13. The first network node of claim 11, wherein the first signal comprises at least one of a UE identifier or a UE location identifier.

14. The first network node of claim 11, wherein the instructions, when executed by the at least one processor individually or collectively, cause the first network node to, based on transmitting the data included in the first signal, receive, from the second network node, a second signal including data with respect to the first signal.

15. The first network node of claim 14, wherein the instructions, when executed by the at least one processor individually or collectively, cause the first network node to:
determine whether a service link is available, the service link corresponding to a link between the UE and the first network node,
in case of that service link is available, based on receiving the second signal, transmit the data included in the second signal, to the UE, and
in case of that service link is unavailable, based on receiving the second signal, store the second signal.

16. The first network node of claim 11, wherein the first network node comprises at least one of a next generation node B (gNB), an evolved node B (eNB), an access and mobility management function (AMF), a mobility management entity (MME), a session management function (SMF), a serving gateway (S-GW), a packet data network gateway (P-GW), a user plane function (UPF), a policy control function (PCF), a network exposure function (NEF), or a proxy data network (Proxy-DN).

17. A second network node comprising:
a transceiver;
memory storing one or more instructions, comprising one or more storage media; and
at least one processor comprising processing circuitry,
wherein the instructions, when executed by the at least one processor individually or collectively, cause the second network node to:
receive, from a first network node, a first signal based on a feeder link is available, the feeder link corresponding to a link between the first network node and the second network node;
store the first signal received from the first network node; and
determine, based on expected location of a user equipment (UE), a third network node to transmit a second signal to a user equipment (UE).

18. The second network node of claim 17, wherein the second network node comprises at least one of a next generation node B (gNB), an evolved node B (eNB), an access and mobility management function (AMF), a mobility management entity (MME), a session management function (SMF), a serving gateway (S-GW), a packet data network gateway (P-GW), a user plane function (UPF), a policy control function (PCF), a network exposure function (NEF), or a proxy data network (Proxy-DN).

19. The second network node of claim 17, wherein the first signal is transmitted by the UE to the first network node and stored in the first network node.

20. The second network node of claim 17, wherein the instructions, when executed by the at least one processor individually or collectively, cause the second network node to determine the third network node using a plurality of parameters comprising at least one of a rotation information, an ephemeris information, or a satellite coverage availability information (SCAI).
